(19) United States
(12) Patent Application Publication
(10) Pub. No.: US 2008/0241608 A1
(43) Pub. Date: Oct. 2, 2008

(54) METHOD OF STARTING UP A FUEL CELL UNDER CONDITIONS IN WHICH WATER MAY FREEZE

(75) Inventors: Yan Zhang, Victor, NY (US); Hubert A. Gasteiger, Rochester, NY (US); Steven R. Falta, Honeoye Falls, NY (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/695,236

(22) Filed: Apr. 2, 2007

(51) Int. Cl. H01M 8/00

(52) U.S. Cl. 429/13

(57) ABSTRACT

A method including starting a fuel cell stack and generating heat in the fuel cell stack to raise the fuel cell stack temperature above 0° C. for each start to eliminate ice in the fuel cell stack before shutdown.

### TECHNICAL FIELD

The field to which the disclosure generally relates includes methods of operating a fuel cell.

### BACKGROUND

Fuel cell stacks may be used in vehicles wherein the stack is exposed to temperatures near or below 0° C. A fuel cell stack operated at temperatures near or below 0° C. produces water that may freeze. The ice may fill all of the cathode electrode void volume resulting in oxygen starvation wherein the stack will not be able to produce any power. FIG. 1 illustrates the freeze start-up voltage profile at 0.1 A/cm² at temperature of −20° C. and −15° C. For a typical electrode at a platinum loading of 0.4 mg/cm² having a thickness of 12 μm and a porosity of 0.65, the ice holding capacity of the electrode is about 8.3 C/cm² (where C is coulombs). The ice holding capacity of a typical membrane (18 μm, 1100 EW and dλ=10) such as those available from Gore, Inc., is approximately 6.3 C/cm². Accordingly, the maximum charge passing through the stack below 0° C. would be approximately 8.3-14.6 C/cm².

### SUMMARY OF EXEMPLARY EMBODIMENTS OF THE INVENTION

One embodiment of the invention includes a method comprising: operating a fuel cell stack comprising starting a fuel cell stack having a temperature below 0° C. and drawing a load on the fuel cell ranging from 75 percent of the maximum to the maximum load that the fuel cell stack is capable of responding to, wherein the maximum load is limited by fuel cell system constraints. The power provided can be greater than that requested by the operator to drive primary and auxiliary devices thereby heating the fuel cell stack as quickly as possible to a temperature above 0° C.

Another embodiment of the invention includes controlling the operation of a fuel cell stack in a vehicle including measuring the stack temperature when a customer requests shut-down of the fuel cell system and if the stack temperature is above a predetermined purge temperature for purging the stack, then shutting down the fuel cell stack, and if the stack temperature is below the predetermined purge temperature then continuing to operate the fuel cell stack and to draw a load from the stack so that the stack heats up until the stack temperature is above the predetermined purge temperature and thereafter shutting down the fuel cell stack.

Other exemplary embodiments of the present invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 illustrates a freeze-start-up voltage profile for a fuel cell stack.

FIG. 2 is a graph of the fuel cell stack heat-up rate and product water generation rate versus current density.

FIG. 3 is a graph of a polarization curve at subzero temperatures for a fuel cell stack.

FIG. 4 is a flow diagram illustrating a method of controlling the operation of the fuel cell stack according to one embodiment of the invention.

FIG. 5 illustrates the start profile of a fuel cell stack plotting current density, cell voltage, cell temperature and stack power against start time.

FIG. 6 is a graph of the purge time for water removal in a fuel cell stack versus temperature.

FIG. 7 illustrates a fuel cell system according to one embodiment of the invention.

### DETAILED DESCRIPTION OF EXEMPLARY EMBODIMENTS

The following description of the embodiment(s) is merely exemplary in nature and is in no way intended to limit the invention, its application, or uses.

One embodiment of the invention includes operating a fuel cell stack including bringing the stack temperature to above 0° C. during start-up, before the cathode electrode is filled with ice. This may require a total charge of Qₜₒₜₐₗ equals 8-15 C/cm². Based on the following thermal balance:

T_{stack(t)}−T_{stack(initial)}=Qₜₒₜₐₗ·(1.4V−E_{cell})/(m·C_{P})

Where T_{stack(t)} represents the temperature of the stack at any given time during start-up, T_{stack(initial)} represents the temperature of the stack at the beginning of the start-up, Qₜₒₜₐₗ represents the total charge passing through the stack, E_{cell} represents the average cell voltage, and mCₚ represents the stack thermal mass. The maximum temperature rise of the fuel cell stack for an allowable total charge depends upon the stack thermal mass and the cell voltage during start-up. Therefore, to maximize start-up reliability, the fastest possible temperature rise should occur according to one embodiment of the invention. This can be accomplished by applying the maximum load, limited by the fuel cell system constraints as described in detail later. Excess energy produced by the fuel cell stack not needed for the primary load device, such as the electrical traction system (ETS), may be used to drive auxiliary devices such as air compressor, cabin heater, coolant heater, fuel cell stack heater etc. or may be stored in a storage device such as a battery. The heat generated by the reaction in the fuel cell may be used to heat up the fuel cell stack so that ice formed in the fuel cell is melted. The heating occurs at the most freeze-sensitive spot, that is, the cathode electrode.

A fuel such as hydrogen may be supplied to the anode side of the fuel cell and an oxidant such as oxygen in the form of air may be supplied to the cathode side of the fuel cell. Water is produced at the cathode catalyst electrode in a manner known to those skilled in the art.

Since the total amount of ice which can be stored in the electrode only amounts to Qₜₒₜₐₗ equals 8-15 C/cm², multiple freeze-starts are only possible if the temperature during starts exceeds 0° C. in order to prevent ice accumulation in the electrodes. Thus, successful multiple freeze-starts require the stack to exceed a temperature of 0° C. during each start-up. This can be accomplished by minimizing the cell voltage during each start-up, and storing excess energy produced until the stack temperature is greater than 0° C.

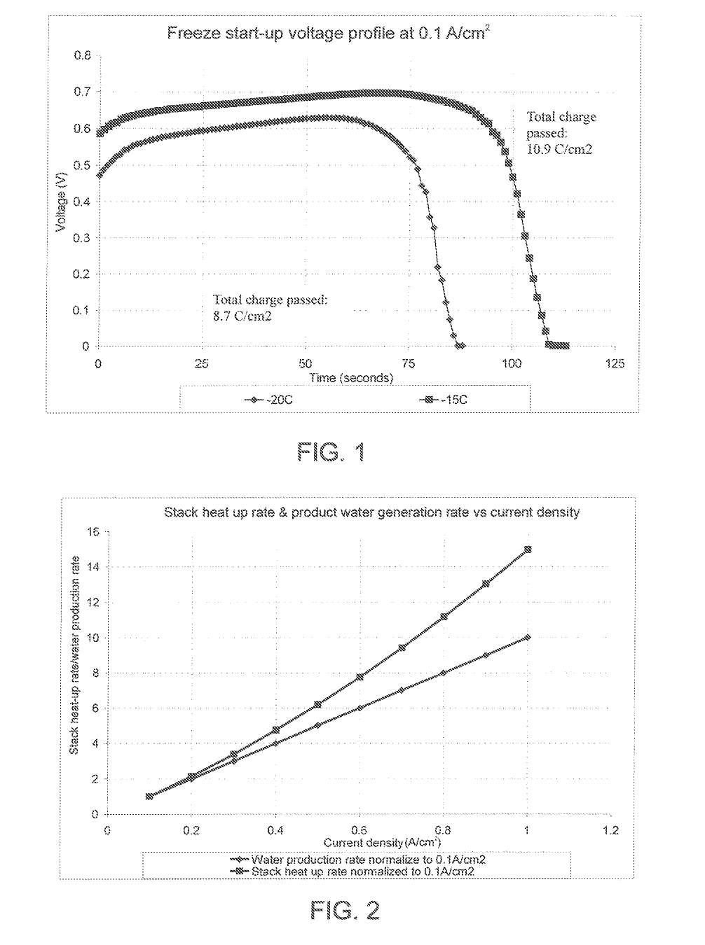

In one embodiment of the invention, the fuel cell is controlled, for example, by a microcontroller, so that during each sub 0° C. start-up, maximum load is drawn to heat up the stack as quickly as possible. The maximum load drawn from the stack will be limited by the fuel cell system constrains. The higher the load drawn, the lower the stack voltage, thus more waste heat can be generated to heat the stack up and thaw any ice accumulated in the electrode. When the stack is heated to a temperature above 0° C., liquid water can be purged out of the stack more efficiently after shut-down. Although drawing a higher load on the fuel cell results in the creation of more product water, at higher loads the stack heats up faster than the rate of the water generation as demonstrated in FIG. 2. Further, as the waste heat is generated at the electrode, the ice accumulated in the electrode can be melted efficiently.

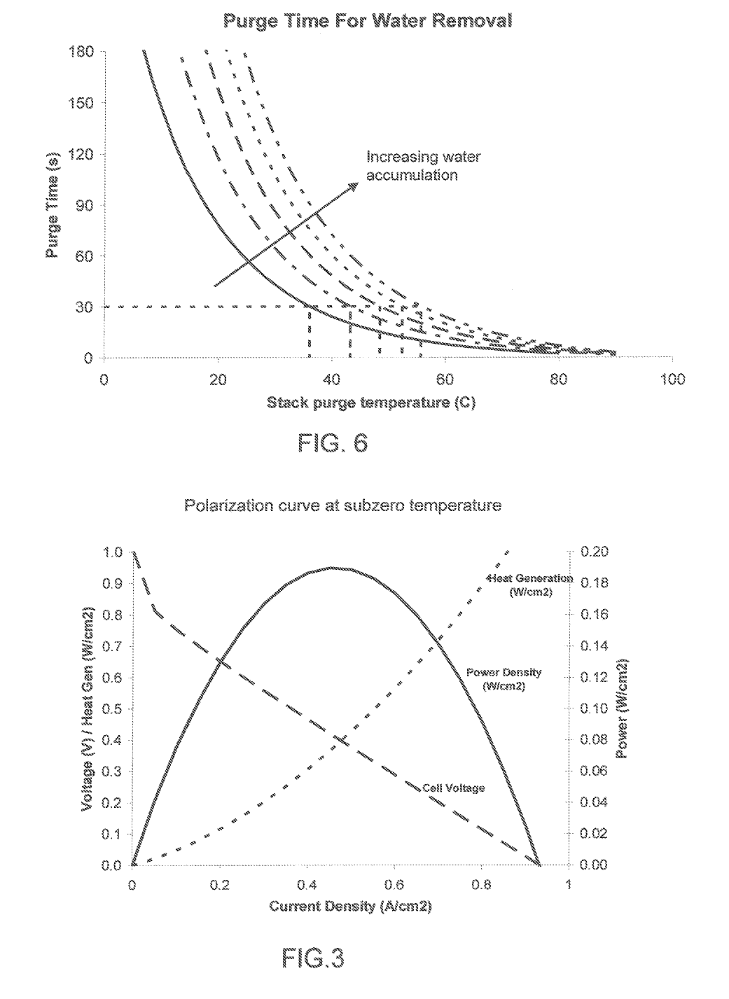

In one embodiment of the invention, energy produced by the fuel cell stack during start-up may be used to drive supplemental heating devices including, but not limited to, electrical heaters directly or indirectly heating the fuel cell stack. In an alternative embodiment, the fuel cell system does not include supplemental heating devices. Stack heating is accomplished solely by internal heat generation. This heat generation, which results from ohmic and electrochemical losses, can be significant if the stack is loaded with a high current. Typically there is a high and low current load which will provide a specific power as illustrated in FIG. 3. The low load is a more efficient condition and results in the lowest heat generation, and the high load is the least efficient and results in greater heat generation. Therefore, to achieve rapid heating, the fuel cell stack may be operated at its highest possible current load. However, this must be balanced with the following system constraints, which may limit the current load and the power output which can be drawn from the stack: (1) minimum cell voltage based on system electronic requirements; (2) maximum current density based on system limitations, for example, at capacity of an air compressor; (3) maximum power generation based upon system requirements; and (4) maximum allowable stack temperature to prevent stack damage.

There is a minimum limit for both individual cell voltage and the average cell voltage of the stack. The minimum cell voltage (V cell) is limited to zero, while the average cell voltage (V avg) of the stack must be greater than zero in order to satisfy the system voltage and power requirements. Cells typically do not perform uniformly during a freeze start and therefore the minimum cell and average voltage can differ. A typical range for these parameters may be as follows: V cell>0; V avg>0.3V.

The maximum current density is limited by the system's design which will have limitations on current and flow. Because of large differences in system designs, the range in maximum current density can vary from 0.6 to 2.0 A/cm². However, for automotive applications, the maximum current density typically is below 1.6 A/cm².

The maximum power that can be drawn will also depend upon the system design and also influenced by the system auxiliary power requirements including compressors, heaters and pumps, operated during the start and the size of the energy storage device, such as a battery. For hybrid and non-hybrid automotive systems, the start and idle power can range from 20-40 kW.

To achieve a successful freeze-start, a sufficient amount of accumulated water must be removed from the stack after shut-down. The accumulated water will depend upon the stack design, system operation conditions and time of operation. As a result, the amount of accumulated water can vary greatly. Typically, a cathode air purge is used to remove this accumulated water and the purge time will depend upon air flow and stack temperature. Purge time decreases as the air flow rate and temperature increases. Because the allocated energy for purge is limited, the necessary purge time is of great importance. For example, as illustrated in FIG. 6, if the purge time is limited to 30 seconds because of power limitations, the necessary purge temperature can vary greatly depending upon the initial accumulated water in the fuel cell stack. In this case, if the fuel cell stack had a small amount of water accumulation, the minimum purge temperature would be 38° C. with the purge temperature increasing with increasing water accumulation. For this fixed purge time, the required purge temperature could range from 30-95° C. The upper temperature should be limited to prevent damage to cell membranes. However, through proper stack operation and design, water accumulation can be minimized and the upper temperature range can be reduced, for example, to 70° C. and below.

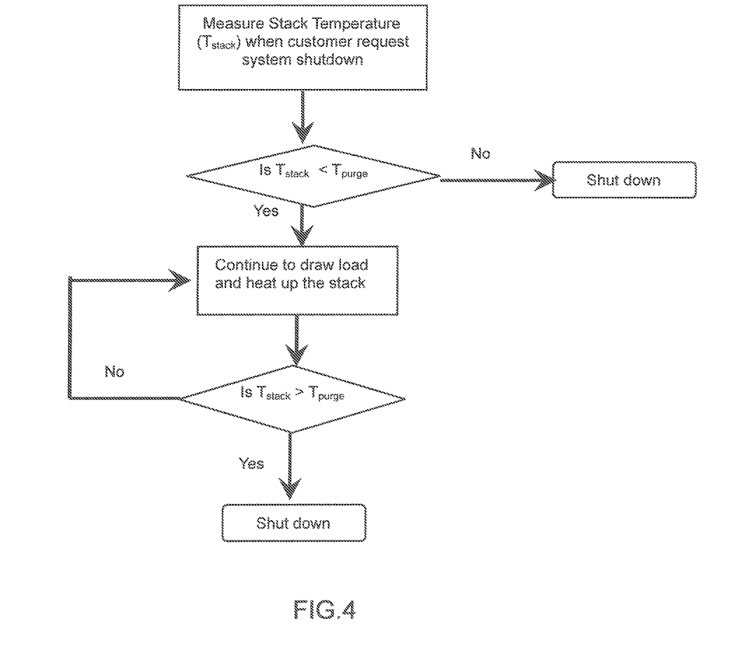

Referring now to FIG. 4, in one embodiment of the invention, the fuel cell system may be controlled by measuring the stack temperature when a driver of a vehicle or operator requests the fuel cell system to be shut down. If the fuel cell stack temperature is greater than a predetermined purge temperature, then the fuel cell stack may be shut down and water purged from the fuel cell stack. The predetermined purge temperature preferably is a temperature above 0° C. so that the fuel cell stack, and particularly the cathode, is free of ice. However, if the fuel cell stack temperature is less than the predetermined purge temperature, then the system is operated to continue to draw a load and to further heat up the fuel cell stack. The temperature of the fuel cell stack is subsequently measured and a load continuously drawn so that the fuel cell stack is heated up until such time that the fuel cell stack temperature exceeds the predetermined purge temperature. Thereafter the fuel cell is shut down (i.e., the flow of fuel to the stack is stopped) and water purged from the fuel cell, for example, by blowing air from an air compressor through the stack for a time sufficient to remove a substantial portion of the water in the stack. Preferably the stack is only shut down when the temperature of the stack is above 0° C.

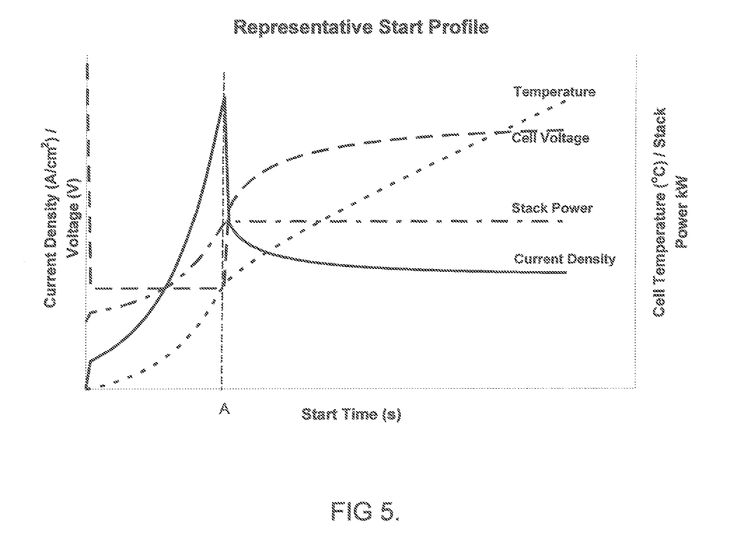

FIG. 5 shows an example of a system start where the customer requests a system shutdown before time A where the temperature of the stack is below the required purge temperature and the power generated is below the maximum allowable power to meet auxiliary power demand. To enable reliable and repeatable start-up, the load will be continuously drawn to heat up the stack. Prior to time A, the power is rapidly increased while constraining the average cell voltage to a minimum voltage, for example, 0.3V and the individual cell voltage to be above 0V. During this period, the stack operates at the least efficient load, which generates more heat to raise the temperature of the stack, for example, from −20° C. relatively quickly. At time A, the maximum allowable power generation is reached after which the current load must be reduced. This improves the stack efficiency, lowers heat generation, and reduces the rate of temperature rise. As the temperature continues to rise, coolant flow can be used to prevent the stack from reaching damaging temperatures. In one embodiment of the invention, to maximize the temperature rise, no coolant flow is used until the maximum allowable temperature is approached or a sufficient purge temperature is reached. To determine sufficient purge temperature the allowable purge flow, purge energy, and estimated water accumulation in the cell prior shut-down are needed. With this information, the necessary stack purge temperature can be determined. For example, as shown in FIG. 6, the required stack purge temperature increases as the water accumulation amounts prior shut-down increases for an allowable purge energy corresponding to 30 seconds.

During some short trip scenarios, the driver might idle and then shut down the vehicle in a couple of minutes. During such a short period of time, as a small amount of power might be required for the Electrical Traction System (ETS) and auxiliaries, in the winter time, the temperature of the stack might not reach above 0° C. using the waste heat of the chemical reaction. Thus the product water will accumulate in the cathode electrode void volume in the form of ice. Purging the stack after shut down is unlikely to remove the accumulated ice in the electrode, because the water carrying capacity of the air is extremely low at subzero conditions. After a couple of such a short trip scenarios, as the accumulated ice plugs the entire void in the cathode electrode, the stack will not be able to generate any power, which is very undesirable for customers since it prevents vehicle operation. This effect will worsen as the start-up temperature is lowered (e.g., −40 C). According to one embodiment of the invention, this problem is solved by a method of heating the fuel cell stack to above 0° C. before shutting the stack down so that the voids in the cathode electrode of the fuel cell stack are not completely plugged with ice and so that oxygen may diffuse to the catalyst surface of the cathode electrode.

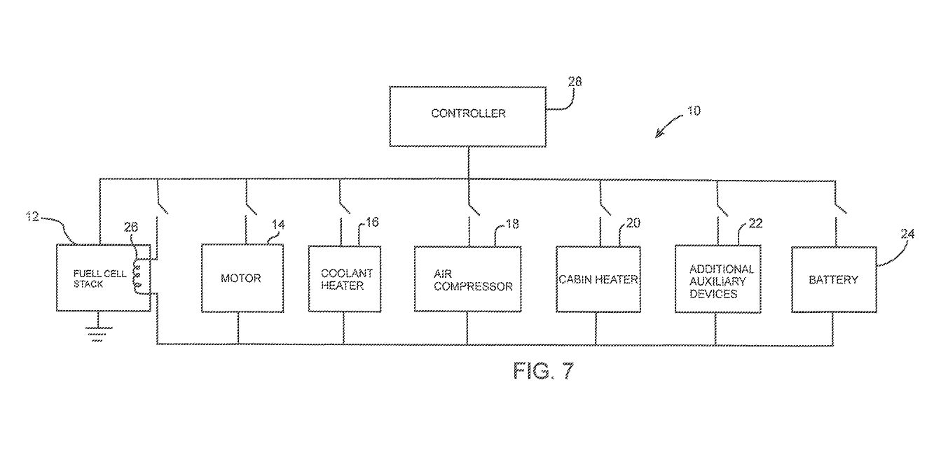

Referring now to FIG. 7, one embodiment of the invention includes a fuel cell system 10 including a fuel cell stack 12, and a plurality of devices connected to the fuel cell stack 12 to be driven by electricity produced by the stack. Such devices may include, but are not limited to, a primary load device 14 such as an electric motor or electrical traction system for propelling a vehicle, a coolant heated 16, an air compressor 18, vehicle passenger cabin heater 20, additional auxiliary devices 22, an electrical energy storage device 24 such as a battery and a stack heater 26. The fuel cell stack 12 and devices 14, 16, 18, 20, 22, 24, 26 may be connected in an electrical circuit with switches to allow the different devices to be selectively driven by electricity from the fuel cell stack as desired and according to the various methods disclosed herein. An electric heating element 26 may be provided in the fuel cell stack 12. For example the electric heating element 26 may be connected to or provided in or on a bipolar plate or end plate of the fuel cell stack 12. A controller 28, such as a microprocessor, is provided to control the operation of the fuel cell stack 12 and devices 14, 16, 18, 20, 22, 24 and 26.

One embodiment of the invention includes a method comprising storing excess electricity produced by the fuel cell in a storage device. Another embodiment of the invention includes a method comprising using excess electricity produced by the fuel cell, not needed to drive primary and auxiliary devices requested by an operator, to drive an air compressor at a speed greater than that required to deliver excess air to the fuel cell stack in response to the load drawn on the fuel cell stack. Excess air to the fuel cell stack is desirable to maximize the carryout of ice and liquid water during start-up. Another embodiment of the invention includes a method wherein the fuel cell stack includes an electrical heating element to heat the fuel cell stack. Another embodiment of the invention includes a method wherein a fuel cell liquid coolant system is connected to the fuel cell stack to flow coolant there through, and an electric heating element is provided in the coolant system and further comprising heating the heating element to heat the coolant in the coolant system and flowing the coolant through the fuel cell stack to heat the fuel cell stack.

The above description of embodiments of the invention is merely exemplary in nature and, thus, variations thereof are not to be regarded as a departure from the spirit and scope of the invention.

What is claimed is:

1. A method comprising operating a fuel cell stack comprising starting a fuel cell stack having a temperature below 0° C. and drawing a load on the fuel cell ranging from 75 percent of the maximum to the maximum load that the fuel cell stack is capable of responding to, wherein the maximum load is limited by fuel cell system constraints and wherein the load drawn is greater than that requested by the operator to drive primary and auxiliary devices and continuing to draw said load in an amount greater that that requested by the operator at least until the temperature of the fuel cell stack is above 0° C.

2. A method as set forth in claim 1 wherein the system constrains include the individual cell voltage>0V and average stack cell voltage>0.3V.

3. A method as set forth in claim 1 wherein the system constrains include the maximum current density in the range 0.6 A/cm²-2.0 A/cm²

4. A method as set forth in claim 1 wherein the system constrains include the maximum power generation during subzero start-up in the range of 20-40 KW

5. A method as set forth in claim 1 wherein the system constraints include a required stack purge temperature of 30-95° C.

6. A method as set forth in claim 5 wherein the required purge temperature is determined by purge airflow, allowable purge energy, and accumulated water.

7. A method as set forth in claim 1 further comprising shutting down the fuel cell stack only when there is no ice held in pores of a cathode electrode of the fuel cell stack at the time of the shutting down.

8. A method as set forth in claim 1 wherein the fuel cell stack is substantially free of ice at the time of shutting down.

9. A method as set forth in claim 1 further comprising purging water from the fuel cell stack when the temperature of the stack is above 0° C.

10. A method as set forth in claim 5 further comprising purging the fuel cell stack before the shutting down, the purging comprises blowing a gas through the fuel cell stack.

11. A method as set forth in claim 10 wherein the gas comprises air.

12. A method as set forth in claim 1 wherein the load includes a primary load drawn by an electrical traction system of a vehicle.

13. A method as set forth in claim 1 further comprising storing excess electricity produced by the fuel cell in a storage device.

14. A method as set forth in claim 1 further comprising using excess electricity produced by the fuel cell, not needed to drive primary and auxiliary devices requested by an operator, to drive an air compressor at a speed greater than that required to deliver excess air to the fuel cell stack in response to the load drawn on the fuel cell stack.

16. A method as set forth in claim 1 wherein the fuel cell stack comprises an electrical heating element therein and further comprising heating the heating element in the fuel cell stack to heat the fuel cell stack.

17. A method as set forth in claim 1 further comprising a fuel cell liquid coolant system connected to the fuel cell stack to flow coolant there through, and an electric heating element in the coolant system and further comprising heating the heating element to heat the coolant in the coolant system and flowing the coolant through the fuel cell stack to heat the fuel cell stack.

18. A method as set forth in claim 1 further comprising a fuel cell liquid coolant system connected to the fuel cell stack to flow coolant there through, and the coolant flowrate to the stack can be regulated to prevent the overheating of the stack during start-up

19. A method as set forth in claim 1 wherein the fuel cell stack is only shut down when the temperature is above 0° C.

20. A method comprising:
controlling the operation of a fuel cell stack in a vehicle including measuring the stack temperature when a customer requests shut-down of the fuel cell stack and if the stack temperature is above a predetermined purge temperature for purging the stack, then shutting down the fuel cell stack, and if the stack temperature is below the predetermined purge temperature then continuing to operate the fuel cell stack and to draw a load from the stack so that the stack heats up until the stack temperature is above the predetermined purge temperature and thereafter shutting down the fuel cell stack.
